(19) United States
(12) Patent Application Publication
(10) Pub. No.: US 2011/0293392 A1
(43) Pub. Date: Dec. 1, 2011

(54) VACUUM OPERATED WASTE COLLECTION CONTAINER AND A USE OF THE CONTAINER

(75) Inventor: Magnus Ekholm, Molndal (SE)

(73) Assignee: ENVAC AB, Stockholm (SE)

(21) Appl. No.: 13/147,649

(22) PCT Filed: Jan. 28, 2010
(86) PCT No.: PCT/SE2010/000022

§ 371 Date: Aug. 3, 2011

(30) Foreign Application Priority Data
Feb. 3, 2009 (SE) 0950036-4

(51) Int. Cl. B65F 1/12; B65G 65/46

(52) U.S. Cl. 414/326

(57) ABSTRACT

A storage container (108) for temporarily storing deposited waste (W) in a vacuum operated waste collection and management system has at least one waste deposit inlet (110A-C), a waste outlet section (120) with a waste discharge opening for the discharge of waste therefrom and a spiral conveyor (111) extended in a first direction through the container, towards the outlet section for assisting discharge of waste from the container via subatmospheric pressure applied through the outlet section. In such a container the spiral conveyor with a screw flight (111A) thereof extends through the waste outlet section and the outlet section includes a waste discharge opening being directed at a considerable angle to a centre axis of the spiral conveyor. Such a storage container may be employed in both vacuum operated waste collection systems of a stationary type and to such systems of a mobile type.

### TECHNICAL FIELD

The present invention generally concerns vacuum operated waste collection and management systems and specifically relates to the means and the process for discharging waste from a storage container used for temporarily storing deposited waste in such systems.

### BACKGROUND

Over the years, waste collection systems of the vacuum operated type have been extensively used in many areas of society as well as in many parts of the world. To cope with the constant demands for increased capacity of such systems it has in recent years become common to provide temporary storage spaces close to the waste deposit points of the systems. With such temporary storage spaces it has been possible to provide effective emptying sequences even for larger systems having a large number of deposit points spread out across an area, such as a large residential area. The positive effects have been enhanced even further by the introduction of the so called “screw tank” having an agitator or conveyor in the form of a screw that assists in discharging waste that has been temporarily collected in the storage space. With such screw tanks it has been possible to increase the temporary storage volume even further.

The presently used screw tanks are mostly configured such that the conveyor screw is supported in a rear wall of the tank and is extended just short of a transition area between the actual tank storage space and a generally outwardly tapering outlet section. The outlet section has a discharge opening that is positioned and opens generally in line with the conveyor screw extension and that communicates with a system transport piping. Such tank configurations may under certain conditions be sensitive to disturbances in the waste discharge, possibly leading to waste blockage in the outlet section or in the discharge opening. In some cases distribution and redistribution of the deposited waste inside the tank is used as a means for enabling optimal use of the storage capacity of the tank. With the present tank configuration, such distribution sequences will in some applications tend to require the use of a blocking means to avoid the distribution or redistribution of waste into the tapered outlet section and consequently the risk of waste blockage therein.

The generally described tank configuration furthermore requires that service spaces are present both outside the rear tank wall and around the outlet section and the discharge valve. These service spaces and the presence of the tapered outlet section make the screw tank a rather space consuming structure that in underground applications requires a comparatively large excavation.

Accordingly, there is a general need for solutions enabling optimal screw tank operation as well as screw tank design.

### SUMMARY

It is a general object of the present invention to find a solution to the above discussed problems by providing improved waste container discharge.

In particular it is an object of the invention to suggest an improved waste storage container for use in a vacuum operated waste collection system and enabling secure and effective waste container discharge.

According to another aspect of the invention it is an object thereof to provide an improved waste container design contributing also to a reduction of the space requirement as well as the costs of the container.

In accordance with other aspects of the invention it is an object of the invention to integrate a waste storage container of the invention in a stationary or a mobile vacuum operated waste collection system, respectively.

These and other objects are met by the invention as defined by the accompanying patent claims.

The invention relates to tanks or containers that are used for temporarily storing deposited waste in vacuum operated waste collection systems. Specifically, it relates to such tanks or containers that are provided with a spiral conveyor for assisting the vacuum discharge of the stored waste from the container to a system transport piping. To achieve disturbance-free waste discharge from the container, a basic idea of the invention is to provide a container wherein the spiral conveyor has a screw flight that extends through the waste outlet section. This enables the retrieval of waste having caused or tending to cause blockage, by reverse operation of the conveyor. By providing an outlet section comprising a waste discharge opening that opens in a direction considerably angled relative to a centre axis of the spiral conveyor the need for separate blocking means will also be eliminated. In this way, the spiral conveyor may be operated effectively to distribute and assist the discharge of deposited waste. Additionally, the container may be designed very compact in the direction of its length since no tapered outlet section is required as a transition to the discharge and its opening.

In accordance with another aspect of the invention the spiral conveyor is extended past the outlet section and is supported in a forward end wall area of the container, closest to the outlet section. It is operated by a drive motor received in a service space at said forward end wall area. This will clearly reduce the container space requirement since there is no longer any need for a service space at each end thereof.

In accordance with a further aspect of the invention at least one temporary waste storage container of the invention is used in a stationary vacuum operated waste collection system.

According to yet another aspect of the invention one or several temporary waste storage containers of the invention are used in a mobile vacuum operated waste collection system.

Preferred further developments of the basic inventive idea as well as embodiments thereof are specified in the dependent subclaims.

Advantages offered by the present invention, in addition to those described above, will be readily appreciated when reading the below detailed description of embodiments of the invention.

### BRIEF DESCRIPTION OF THE DRAWINGS

The invention, together with further objects and advantages thereof, will be best understood by reference to the following description taken together with the accompanying drawings, in which:

FIG. 1 is a schematical illustration of vacuum operated waste collection and management systems to which the container according to the invention may be applied;

FIG. 2 is a side view of a first embodiment of a storage container of the invention;

FIG. 3 is a longitudinal section along line A-A, through the container of FIG. 2;

FIG. 4 is an end view of the storage container of FIG. 2;

FIG. 5 is a longitudinal section along line B-B in FIG. 4, through the container of FIGS. 2-4;

FIG. 6 is a top perspective view of the storage container of FIG. 2;

FIG. 7 is a side view of a second embodiment of a storage container of the invention;

FIG. 8 is a cross section through the container of FIG. 7, taken along line C-C therein;

FIG. 9 is a longitudinal section along line D-D in FIG. 7, through the container of FIGS. 7-8;

FIG. 10 is a longitudinal section along line E-E in FIG. 8, through the container of FIGS. 7-8; and

FIG. 11 is a top perspective view of the storage container of FIG. 7.

### DETAILED DESCRIPTION

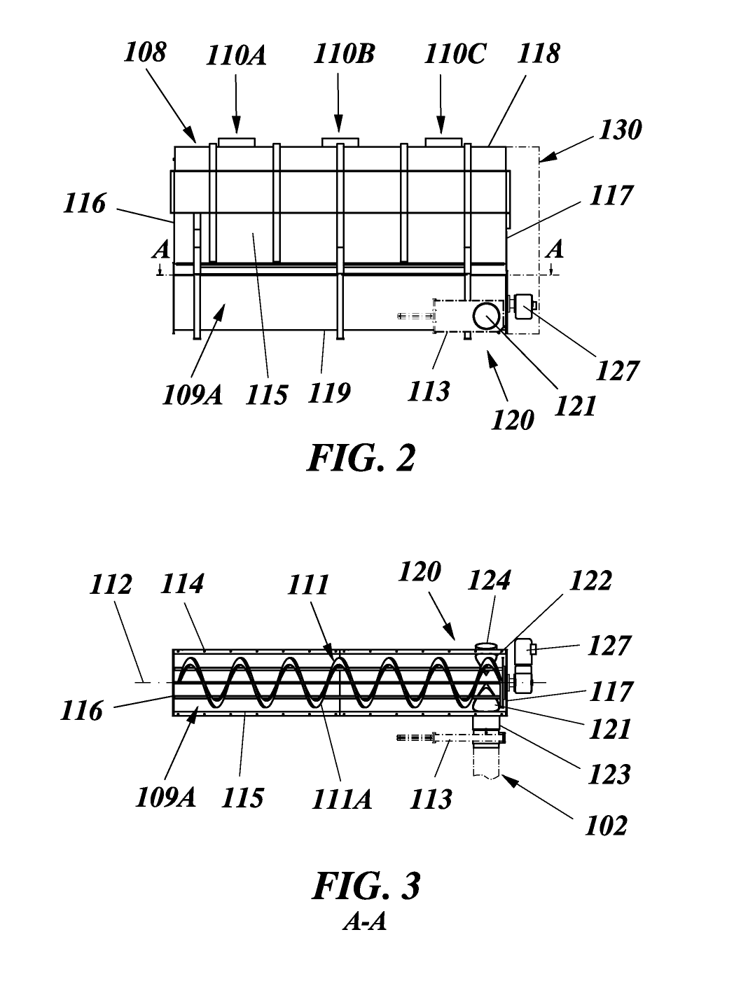

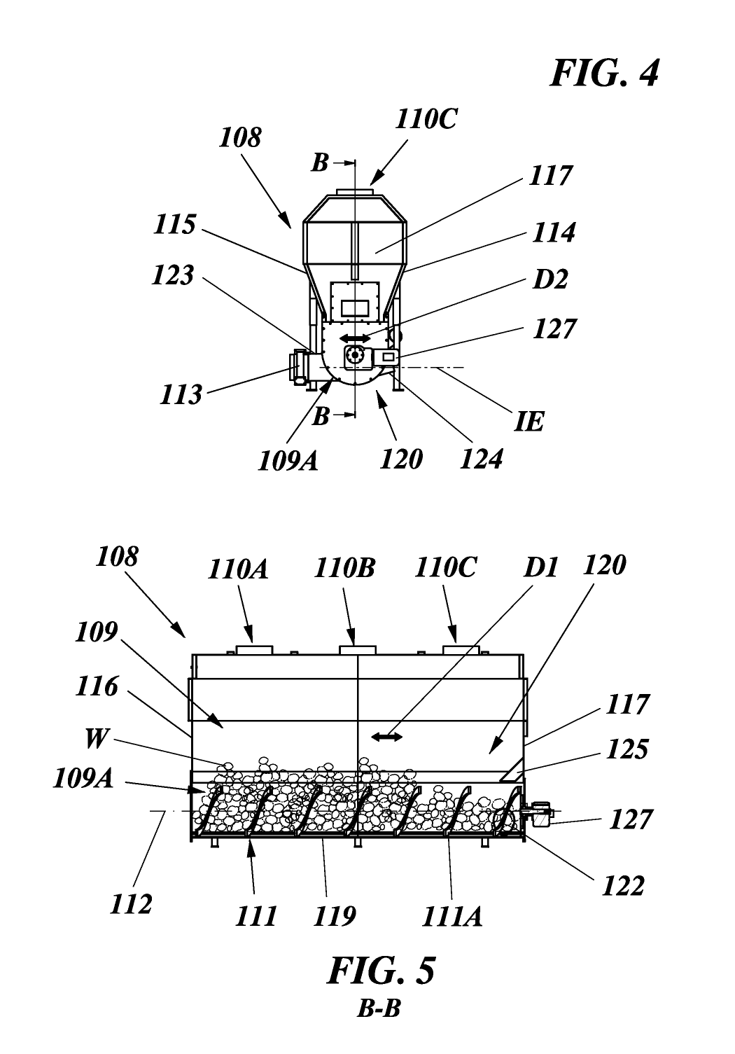

The invention will now be explained with reference to exemplifying embodiments of the temporary storage container of invention, which are illustrated in the accompanying drawing figures. A first exemplifying embodiment of the invention is illustrated in FIGS. 2-6, and relates to an application of the inventive solution to a storage container intended specifically for use in a stationary type vacuum operated waste collection system. It shall be emphasized, though, that the illustrations are for the purpose of describing preferred embodiments of the invention and are not intended to limit the invention to the details thereof.

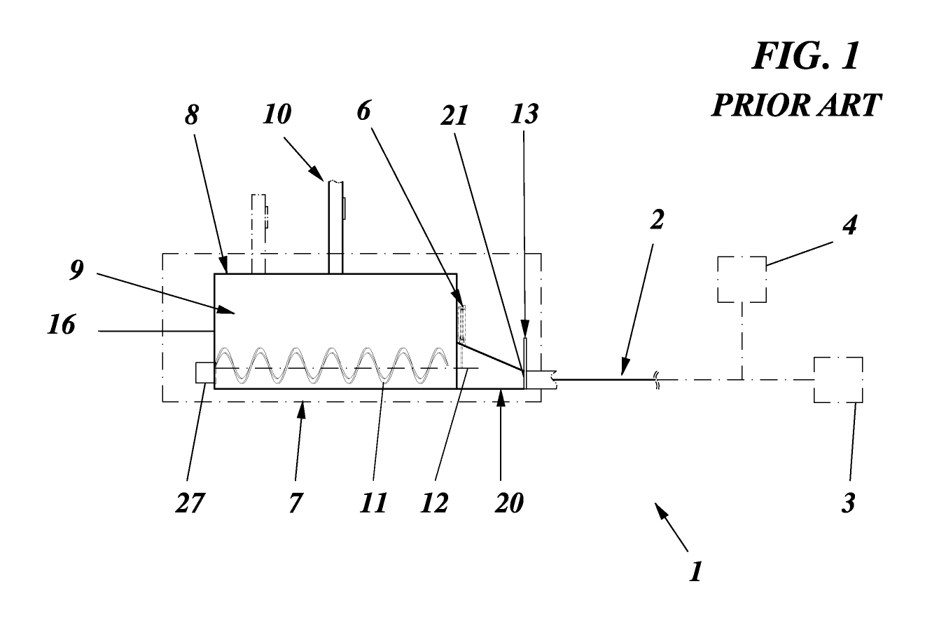

One type of present day container for the storage of waste in vacuum operated waste collection systems employs a spiral conveyor for assisting container discharge. As was described briefly in the introduction and is illustrated schematically in FIG. 1 such a prior container configuration 8 may typically be received either in a building above ground or in a bunker-like underground chamber 7. The container is integrated in a vacuum operated waste collection and management system 1 that has transport piping 2 wherein waste is conveyed from the container 8. The system 1 may either be of the stationary type where deposited waste is conveyed to a central waste collection terminal 3 or of the mobile type where deposited waste is conveyed to a docking point 4 to which a waste truck is connectable. In this container configuration one or several waste inlets 10 are provided in the upper part of the container 8 for receiving deposited waste and introducing it into the actual container storage space or chamber 9. A spiral conveyor 11, normally in the shape of a shaftless screw, is supported in a rear wall 16 of the container 8, is extended towards a container outlet section 20 and is operated by a drive motor 27 that is likewise supported in said rear wall 16. The centre line 12 of the conveyor 8 is normally generally horizontal and the conveyor is extended over a major portion of the storage chamber 9 but ends short of the outlet section 20. The outlet section 20 is tapered in a direction from the storage chamber 9 towards a container discharge opening 21 to properly guide conveyor agitated waste towards the latter. The discharge opening 21 communicates with the transport piping 2, either directly or controlled by a discharge valve 13. Both the outlet section 20 and the discharge opening 21 are provided generally aligned with the conveyor 11.

With such a prior art container solution, and especially in containers 8 that require some kind of waste distribution process to achieve optimum use of the storage space 9, it will be necessary to provide an above briefly mentioned blockage means 6 that shall serve to prevent that the performed waste distribution sequence forces waste in to the tapered outlet section to cause blockage therein. Even with such measures taken, disturbances in the waste discharge, such as blockage, cannot be fully excluded with this container configuration The provision of the tapered outlet section 21 and of the blockage means 6 also adds quite significantly to the production costs, as does the service space requirement at both ends of the container 8, for access to the conveyor drive motor 27 as well as to the discharge area with its discharge valve 13 and/or control equipment. Not only does this make the overall container dimensions larger, but it also adds to the costs for providing the suitable, comparatively large space required for the container of an indoor application in ground or basement level. The same applies to underground applications where a comparatively large excavation and a corresponding container accommodating chamber structure are required.

To overcome the above described disadvantages and problems associated with both the discharge process and the production of the known container and its installation, the present invention suggests a new approach to such container configuration. In accordance with the solution presented by the invention advantageous improvements are achieved in terms of a practically disturbance-free discharge and a reduced fabrication and installation cost. Basically, all of the advantageous effects of the invention are achieved by the unique extension of the spiral conveyor into and through the container outlet section and by the likewise unique positioning of the discharge such that it opens in a direction at a considerable angle to the conveyor extension.

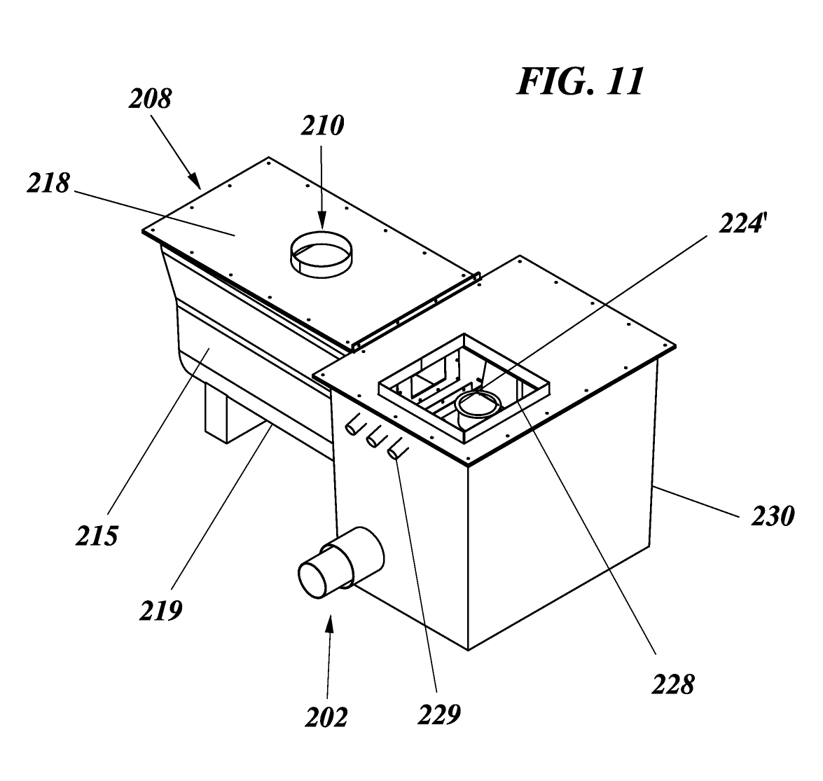

The invention will be explained below with reference to exemplifying embodiments thereof that are illustrated in the accompanying drawing FIGS. 2 to 11. In said drawing figures are disclosed schematical embodiments of the inventive container configuration. Like many conventional container configurations for vacuum operated waste collection systems, the embodiments of the invention may fairly easily be adapted for positioning in a building above ground as well as in an underground bunker or chamber and for use in a stationary type system as well as in a mobile type system. It shall therefore be emphasized, that although the embodiments of the invention may be described in variants intended especially for either of the above alternatives, the invention shall not be restricted to such specified applications thereof. Instead, in the applicable cases, the container embodiments of the invention may be used for both types of installations and for both types of systems. Generally, as will become clear from the following description, the invention therefore covers embodiments combining features from the described embodiments, as required for different applications.

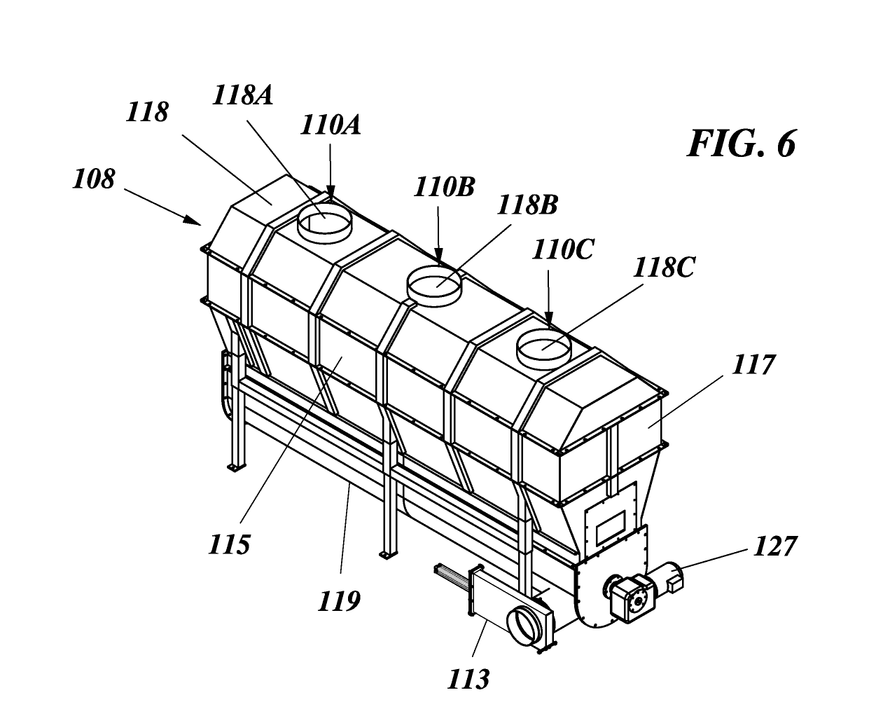

FIGS. 1-6 schematically disclose a first exemplary embodiment of an inventive waste storage container configuration 108 that is specifically intended for use in an installation above ground in a vacuum operated waste collection and management system, as generally described above. In this embodiment the container 108 has a generally elongated basic shape in its extension between rear and front end walls 116 and 117, respectively. These end walls 116, 117 together with side walls 114 and 115 and top and bottom walls 118 and 119, respectively, enclose a container storage space or volume 109 (FIG. 5). The side walls 114, 115 are profiled to give the storage space 109 a generally downwardly tapering shape, forming a lower trough-shaped section 109A (see especially FIGS. 2-4) wherein the spiral conveyor 111 is accommodated. To the top wall 118 of the container 108 are connected a number of, here three, waste deposit inlets 110A-C that are only illustrated by their lowermost container connection in the drawing figures. Through the waste inlets 110A-C, which may either be a waste chute (indicated in FIG. 1) in a multi-story building or a free-standing waste deposit inlet (likewise indicated in FIG. 1), waste W (FIG. 5) is deposited in the storage container 108 through a corresponding waste deposit opening 118A-C (see FIG. 6) in the container top wall 118.

A waste outlet section 120 is in this embodiment part of the actual storage container 108 and is present adjacent to the container front end wall 117 and mainly in the lower trough-shaped section 109A. This outlet section 120 comprises a waste discharge opening 121 from which stored waste W is discharged from the container and into a system transport piping 102 through an appropriate connection means 123 that is normally a pipe section. The discharge opening 121 is located approximately at a transition area between the bottom container wall 119 and the corresponding side wall 115, at least partly in the side wall area. Said discharge opening 121 faces in a direction that forms a considerable angle with the direction of extension of the spiral conveyor 111 in the trough-shaped section 109A, or specifically to the centre line 112 of the conveyor. 111. Depending upon the system configuration the waste discharge may be performed directly into the transport piping 102 or through a discharge valve 113, as is well known within this field. In such a case the container discharge valve 113 may in the illustrated container configuration be provided at a side wall area 115 of the container 108.

The spiral conveyor 111, here in the shape of a shaftless screw conveyor, is extended in a first generally horizontal direction D1 through the lower trough-shaped section 109A of the container 108. The spiral conveyor 111 is provided close to the bottom wall area 119 of the container 108 and passes through an imaginary extension IE of the system transport piping 102 at a bottom area of the waste outlet section 120. Furthermore, the conveyor 111 is extended approximately at a level with the waste discharge opening 121 and its connection means 123, which may be said to open or to be directed in a horizontal second direction D2 being generally transversal to the first direction D1. According to the invention the conveyor 111, and specifically its active screw flight 111A, extend at least substantially through the entire waste outlet section 120. In the specific illustrated embodiment the spiral conveyor 111 and its drive motor 127 are supported in the front end wall 117 of the container 108 that is provided closest to the outlet section 120, such that the conveyor 111 and its screw flight 111A extend fully through the entire waste outlet section 120 and completely past the waste discharge opening 121. The other free end of the conveyor 111 ends just short of the container 108 rear wall 116. As is indicated very schematically in FIG. 2 the conveyor drive motor 127 may, especially in underground applications, be received in a service space 130 at said forward container end wall area 117.

An air inlet opening 122 is provided at an opposite position to the discharge opening 121, meaning that it is positioned in a transition area between the bottom wall 119 and the opposite container side wall 114. Naturally, the discharge opening 121 and the air inlet 122 could switch sides. In fact, this illustrated air inlet 122 is only one example of several optional single or combined air inlet positions, such as in the front end wall 117 or as a combination with a waste diverter 125 provided in the container 108, at a position generally above the spiral conveyor 111 and below the at least one waste deposit inlet 110A, 110B, 110C and at or slightly upstream of the waste outlet section 120. The waste diverter 125 prevents waste from falling down directly into the actual outlet area 120. This might otherwise happen as the conveyor 111 feeds the bulk of waste W forward and could cause blockage therein. Specifically, it is in most cases preferred that the area directly below the diverter 125 is maintained free from waste bags that fall down freely. Instead, waste that is to be discharged from the container 108 should preferably be advanced up to and in the outlet area 120 by and inside the conveyor 111. Another advantage of the diverter 125 is that it enables an increase of the discharge rate with maintained operational reliability.

The air inlet opening 122, or each such air inlet opening, may comprise air inlet connection means 124, such as a pipe section, that is likewise extended at a considerable angle relative to the centre axis 112 of the spiral conveyor 111 and that serves to conduct air from a particular location and into the air inlet opening 122.

In operation, the spiral conveyor 111 serves on the one hand to advance the collected waste W towards and into the outlet section 120 to assist the discharge of waste from the container 108 by means of subatmospheric pressure applied through the outlet section discharge opening 121. The transport air is introduced through the air inlet opening 122 and is directed down towards the conveyor 111 to mix waste W and introduced air and to thereby obtain an air and waste discharge from the container 108. This introduction of transport air does in combination with the applied vacuum pressure pull waste out from the container 108. This process may preferably be supervised in the manner disclosed in our earlier International Patent Application WO 2006/135296 A1.

A specific and unique effect of the container configuration of the invention is the above briefly discussed blockage preventing as well as blockage loosening action of the conveyor 111. This effect is obtained primarily by the extension of the conveyor 111 through the outlet section 120 and past the discharge opening 121 that is directed at a considerable angle, in the illustrated embodiment generally transversely, thereto. In particular, blockage tendencies may be effectively avoided by operating the conveyor 111 in opposite directions to redistribute waste W and allow its secure discharge from the container/discharge opening.

In variations of the described embodiment of FIGS. 2-6, details of the container configuration may be altered to suit specific applications and such variations are likewise covered by the invention. Some exemplifying examples of such variations will now be given. The waste discharge opening at a lower level, and may be provided in any of the two side wall areas 114, 115 or even in the bottom wall area 119. Likewise, the conveyor 111 may, along with its drive motor 127, be supported in the rear wall 116, and in such an embodiment the conveyor does not have to be extended fully through the entire outlet section 120, but may end at a slight distance from the front end wall 117. The container of the invention is not restricted to the use of the illustrated shaftless type of screw, but also covers applications using ordinary screw conveyors having a central shaft and being supported at both ends.

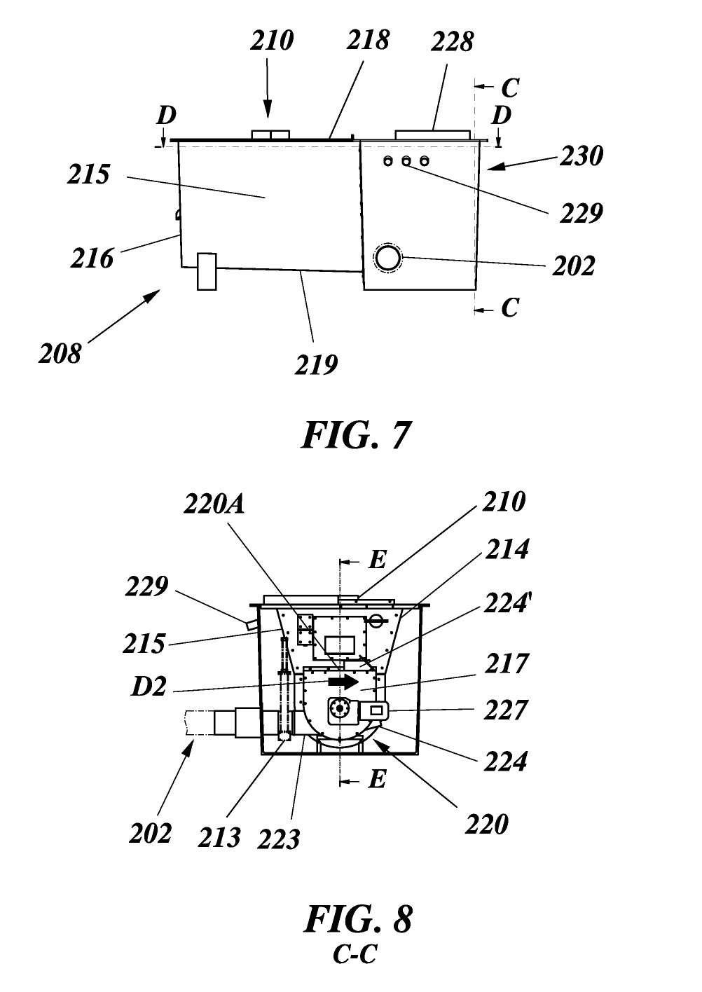

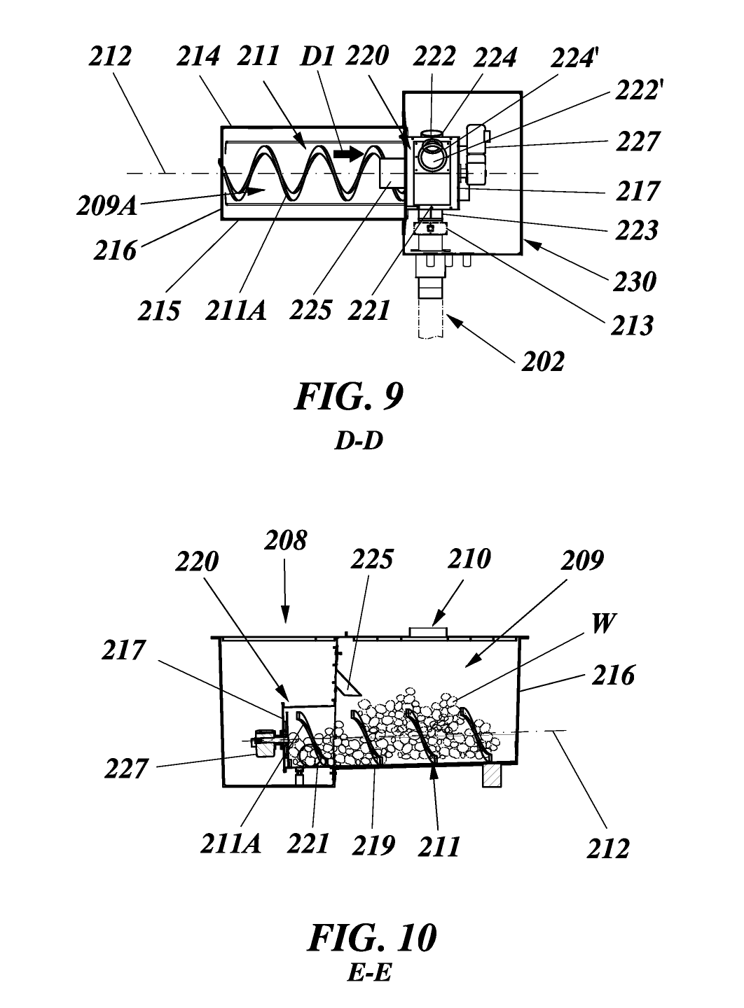

A slightly modified second embodiment of the container 208 of the invention is illustrated in FIGS. 7-11. This second embodiment is based on the same general principles as the described first embodiment and therefore only major differences will be described in detail below. Corresponding or similar parts have been given the same reference numeral with the addition of 100, so that whereas the container of the first embodiment has the reference numeral 108 the container of the second embodiment has the numeral 208. This second embodiment is, as disclosed, primarily intended for an underground application and may be used in stationary as well as mobile vacuum operated waste collection systems. It may advantageously be used for managing compostable waste. In this container 208 the waste outlet section 220 is a partial continuation of the actual storage container space or chamber 209 (FIG. 10), or specifically of the trough-shaped section 209A (FIG. 9) thereof that accommodates the spiral conveyor 211. The spiral conveyor 211 is again supported in the front end wall 217 of the container 208, or here actually of the outlet section 220 or of the trough-shaped section 209A accommodating the spiral conveyor 211 and its screw flight 211A close to the bottom wall 219. The outlet section 220 along with the drive motor 227, the pipe section means 223 for connection to the waste discharge opening 221 and to a system transport piping 202, the air inlet 222 and its connecting means 224 and, in the applicable case the discharge valve 213, are in this embodiment that is intended for an underground application, all received in and enclosed by a service space 230 having an access opening 228 and bushings 229 for electric or other cables.

The waste diverter 225 is here provided in the actual container space 209, likewise generally above the spiral conveyor 211 and below the single waste deposit inlet 210 in the upper wall 218, but in this case slightly upstream of the waste outlet section 220. The air inlet 222 is provided at and enters the outlet section 220 at a side wall 214 thereof (or at a transition between the side wall and a bottom wall 219). An alternative positioning of the air inlet 222′ and its connecting means 224′ in an upper wall 220A of the outlet section 220 is indicated in FIGS. 8, 9 and 11.

Further alternative, but not specifically illustrated embodiments of the invention, other than the mentioned variations of the illustrated containers, may be employed without departing from the scope of the invention. One example thereof is the use of slightly differently oriented discharge openings. In all of the illustrated embodiments the discharge openings are directed generally transversal to the conveyor centre line but it shall be emphasized that the invention covers any angular relationship between the conveyor centre line and the direction of the discharge opening and its connection means, that differs considerably from a straight line. Such an angular relationship may preferably lie in the area of between 45 and 90°.

The invention has been described in connection with what is presently considered the most practical and preferred embodiments, but it shall be understood that the invention is not limited to the disclosed embodiments. The invention likewise covers any feasible combination of the features of the various described and illustrated embodiments of the invention. The invention is therefore intended to cover various modifications and equivalent arrangements included within the spirit and scope of the appended claims.

1-15. (canceled)

16. A storage container (8; 108; 208) for temporarily storing deposited waste (W) in a vacuum operated waste collection and management system (1) and having at least one waste deposit inlet (10; 110A, 110B, 110C; 210), a waste outlet section (20; 120; 220) with a waste discharge opening (21, 121, 221) for the discharge of waste therefrom and a spiral conveyor (11; 111; 211) extended in a first direction (D1) through the container, towards the outlet section for assisting discharge of waste from the container by means of subatmospheric pressure applied through the outlet section, wherein:
the outlet section comprises a waste discharge opening (121; 221) being directed generally transversal to and preferably at an angle of between 45 and 90° relative to a centre axis (112; 212) of the spiral conveyor; and
the spiral conveyor with a screw flight (111A; 211A) thereof extends through the waste outlet section, completely past the waste discharge opening (121; 221).

17. The container (108; 208) according to claim 16, wherein the spiral conveyor (111; 211) extends at least substantially through the entire waste outlet section (120; 220).

18. The container (108; 208) according to claim 16, wherein the waste outlet section (120; 220) waste discharge opening (121; 221) has means (123; 223) that are likewise extended generally transversal to and preferably at an angle of between 45 and 90° relative to the centre axis (112; 212) of the spiral conveyor (111; 211) and that serve to connect said waste discharge opening to a system transport piping (102; 202), either directly or through a discharge valve (113; 213).

19. The container (108; 208) according to claim 16, wherein the spiral conveyor (111; 211) with its screw flight (111A; 211A) extends in a generally horizontal first direction (D1) through the waste outlet section (120; 220), approximately at a level with the waste discharge opening (121; 221) that is formed at least partly in one of two side wall areas (114, 115; 214, 215) of the container and is directed in a generally horizontal second direction (D2) being generally transversal to the first direction.

20. The container (108; 208) according to claim 16, wherein the spiral conveyor (111; 211) is a shaftless conveyor screw that is supported in one of two end wall areas (116, 117; 216, 217) of the container.

21. The container (108; 208) according to claim 16, wherein the waste outlet section (120; 220) comprises at least one air inlet opening (122; 222) formed in a side wall area (114, 115; 214, 215) or alternatively in an end wall area (117; 217) of the container and each having means (124; 224) for connection to a transport air supply.

22. The container (108) according to claim 18, wherein the waste outlet section (120) is part of an actual container storage space (109) and that the means (123) for connection to a system transport piping (102) is a pipe section connected to the waste discharge opening (121).

23. The container (208) according to claim 18, wherein the waste outlet section (220) is a partial continuation of an actual container storage space (209) and that the means (223) for connection to a system transport piping (202) is a pipe section connected to the waste discharge opening (221).

24. The container (108; 208) according to claim 16, further comprising a waste diverter (125; 225) provided in the container, at a position generally above the spiral conveyor (111; 211) and below the at least one waste deposit inlet (110A, 110B, 110C; 210) and at or slightly upstream of the waste outlet section (120; 220).

25. The container (108; 208) according to claim 18, wherein the spiral conveyor (111; 211) extends close to a bottom wall area (119; 219) of the container and passes through an imaginary extension (IE) of the system transport piping (102; 202) through a bottom area of the waste outlet section (120; 220).

26. The container (108; 208) according to claim 16, wherein the spiral conveyor (111; 211) extends completely past the outlet section (120; 220), is supported in a forward end wall area (117; 217) of the container that is provided closest to the outlet section (120; 220) and is operated by a conveyor drive motor (127; 227) that is received in a service space (130; 230) at said forward end wall area.

27. A container (208) according to claim 26, further comprising a container discharge valve (213) received in the same service space (230) as the conveyor drive motor (227), and wherein said service space encloses the container outlet section (220).

28. The container (108) according to claim 18, wherein the container discharge valve (113) is provided at a side wall area (114, 115) of the container.

29. A stationary type of vacuum operated waste collection system (1) comprising the container (108; 208) according to claim 18 wherein the waste transport piping (2; 102) is structured and arranged to be connected to a central waste collection terminal (3).

30. A mobile type of vacuum operated waste collection system (1) comprising the container (108; 208) according to claim 18 wherein the waste transport piping (2; 202) is structured and arranged to be connected to a waste truck docking point (4).

31. The container (108; 208) according to claim 17, wherein the waste outlet section (120; 220) waste discharge opening (121; 221) has means (123; 223) that are likewise extended generally transversal to and preferably at an angle of between 45 and 90° relative to the centre axis (112; 212) of the spiral conveyor (111; 211) and that serve to connect said waste discharge opening to a system transport piping (102; 202), either directly or through a discharge valve (113; 213).
